(19) United States
(12) Patent Application Publication
(10) Pub. No.: US 2023/0039795 A1
(43) Pub. Date: Feb. 9, 2023

(54) IDENTIFYING A USER EQUIPMENT, UE, FOR SUBSEQUENT NETWORK REESTABLISHMENT AFTER A RADIO LINK FAILURE DURING AN INITIAL NETWORK ESTABLISHMENT ATTEMPT

(71) Applicant: Telefonaktiebolaget LM Ericsson (publ), Stockholm (SE)

(72) Inventors: Wojciech Potentas, Lodz (PL); Patrycja Ciepielewska, Kraków (PL); Jakub Niezgoda, Lodz (PL); Jan Felchner, Lodz (PL); Michael Socha, Kraków (PL); Hongsik Kim, Seoul (KP); Youngjin Jung, Seoul (KP); Peter Rehnberg, LINKÖPING (SE)

(21) Appl. No.: 17/491,225

(22) Filed: Sep. 30, 2021

Related U.S. Application Data
(60) Provisional application No. 63/230,445, filed on Aug. 6, 2021.

(51) Int. Cl. H04W 76/19; H04W 76/11

(52) U.S. Cl. CPC H04W 76/19; H04W 76/11

(57) ABSTRACT

A method in a network node includes receiving a radio resource control (RRC) connection reestablishment request from a user equipment (UE). The method includes generating a new Long identifier, ID, for the UE. The method includes determining whether a UE Context Fetch is successful. The method includes responsive to determining that the UE Context Fetch is not successful, determining whether a Long ID has been fetched. The method includes responsive to determining that the Long ID has been fetched, placing the Long ID that has been fetched in a UE Context Fetch Failure event.

### CROSS-REFERENCE TO RELATED APPLICATIONS

This application claims the benefit of U.S. Provisional Application No. 63/230445 filed on Aug. 6, 2021, the disclosure and content of which is incorporated by reference in its entirety.

### TECHNICAL FIELD

The present disclosure relates generally to communications, and more particularly to communication methods and related devices and nodes supporting wireless communications.

### BACKGROUND

Information and communication technology (ICT) carriers want to be able to track an individual user equipment, UE, across the whole lifetime of the UE in a network of the ICT carrier. Reasons for this are for emergencies where the user of the UE has to be contacted or has contacted emergency personnel for assistance, for charging for use of the network, etc.

There currently exist certain challenge(s). One challenge is to trace the UE during RRC-Reestablishment because the network (e.g., radio access network (RAN)) has no notion of any previously assigned unique identifier for the UE. RRC-Reestablishment carries the whole UE Context but the UE ID is forgotten in some cases.

### SUMMARY

To do this without impersonating the subscriber it is needed to have some long random number to be attached as ID for the UE. The reason for regarding the problem and solution as real from a system point of view is when a Customer wants to have survival of the UE ID as well as separation of UE Context with ID data in messages what makes fetching of UE ID still possible even when UE Context cannot be fetched. There is also a last failure option when both information elements cannot be fetched.

Certain aspects of the disclosure and their embodiments may provide solutions to these or other challenges. According to some embodiments, a RAN node generates a temporary identifier that can then be mapped to the identifier or identifiers that are subsequently obtained when the RAN node has fetched them as part of the former UE context. The temporary identifier is a very large (long) random number (LongID), such that the risk of collisions when used in the context of the network node, over a short period of time should be very rare. Mapping back to the identifiers can be completed independently from resumption of retrieval of the full UE context.

According to some embodiments, a method in a network node includes receiving a radio resource control, RRC, connection reestablishment request from a user equipment, UE. The method includes generating a new Long identifier, ID, for the UE. The method includes determining whether a UE Context Fetch is successful. The method includes responsive to determining that the UE Context Fetch is not successful, determining whether a Long ID has been fetched. The method includes responsive to determining that the Long ID has been fetched, placing the Long ID that has been fetched in a UE Context Fetch Failure event.

According to other embodiments, network nodes and computer programs having similar operations are also provided.

Certain embodiments may provide one or more of the following technical advantage(s). With the various embodiments described herein, it becomes possible to trace Long ID even during failure of RRC-Reestablishment and to map the newly generated Long ID just after UE has connected and before RRC-Reestablishment with one retained during RRC-Reestablishment.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flow chart illustrating a Long ID survival of RRC-Reestablishment according to some embodiments of inventive concepts;

FIG. 2 is a flow chart illustrating postprocessing of trace records to match a retained LongID with an old Long ID according to some embodiments of inventive concepts;

FIG. 3 is a signaling diagram illustrating the ability to read LongID from early states of RRC Reestablishment according to some embodiments of inventive concepts;

FIG. 4 is a block diagram illustrating a radio link failure where a UE has LongID bound and lost the link with the cell according to some embodiments of inventive concepts;

FIG. 5 is a signaling diagram illustrating message in RRC Reestablishment and Trace Records reporting according to some embodiments;

FIG. 6 is a block diagram illustrating a wireless device UE according to some embodiments of inventive concepts;

FIG. 7 is a block diagram illustrating a radio access network RAN node (e.g., a base station eNB/gNB) according to some embodiments of inventive concepts;

FIG. 8 is a block diagram illustrating a core network CN node (e.g., an AMF node, an SMF node, etc.) according to some embodiments of inventive concepts;

FIGS. 9-12 are flow charts illustrating operations of a network node according to some embodiments of inventive concepts;

FIG. 13 is a block diagram of a communication system in accordance with some embodiments;

FIG. 14 is a block diagram of a user equipment in accordance with some embodiments

FIG. 15 is a block diagram of a network node in accordance with some embodiments;

FIG. 16 is a block diagram of a host computer communicating with a user equipment in accordance with some embodiments;

FIG. 17 is a block diagram of a virtualization environment in accordance with some embodiments; and

FIG. 18 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art. , in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

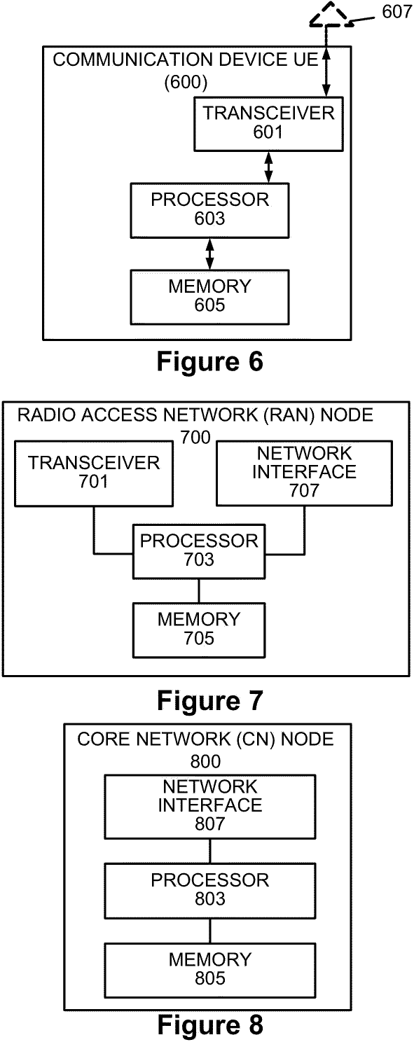

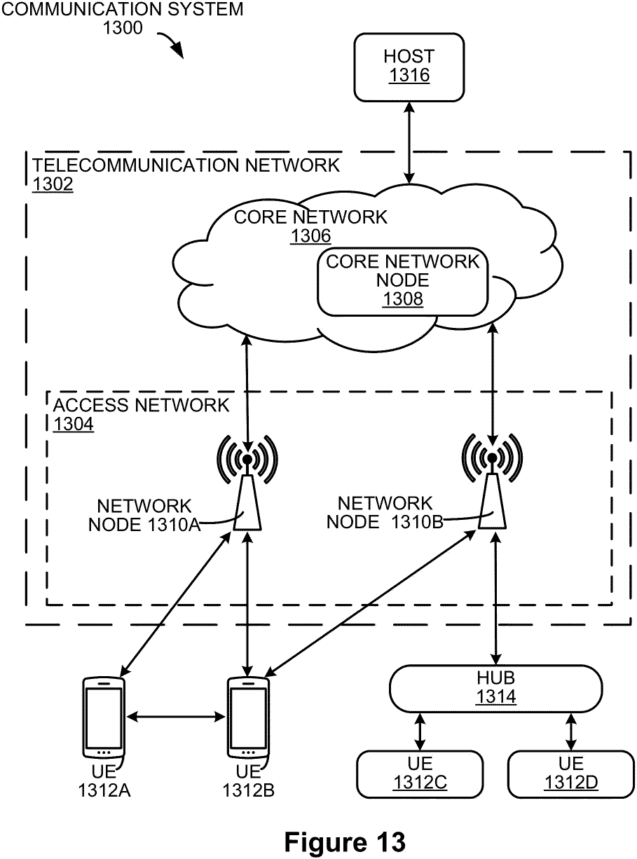

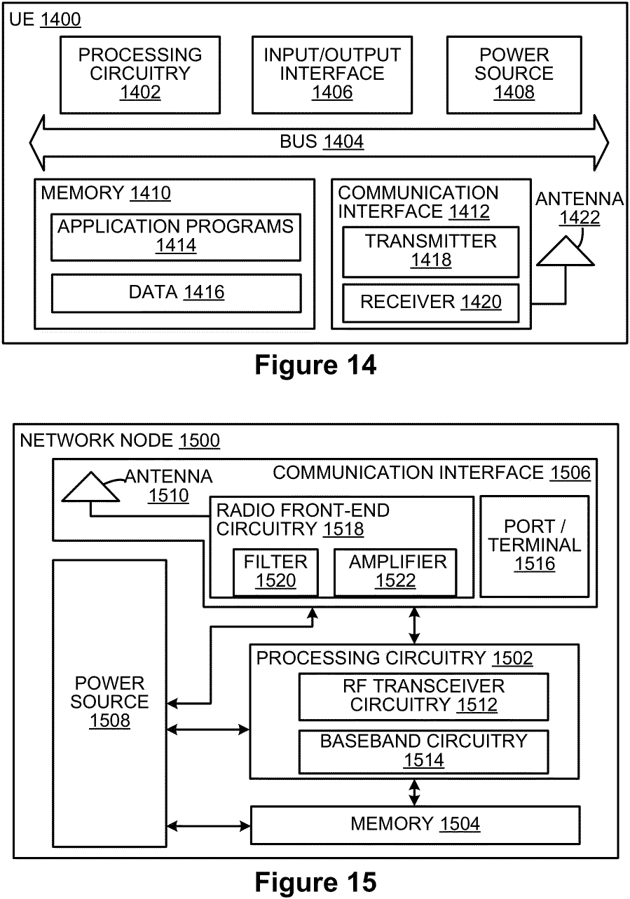

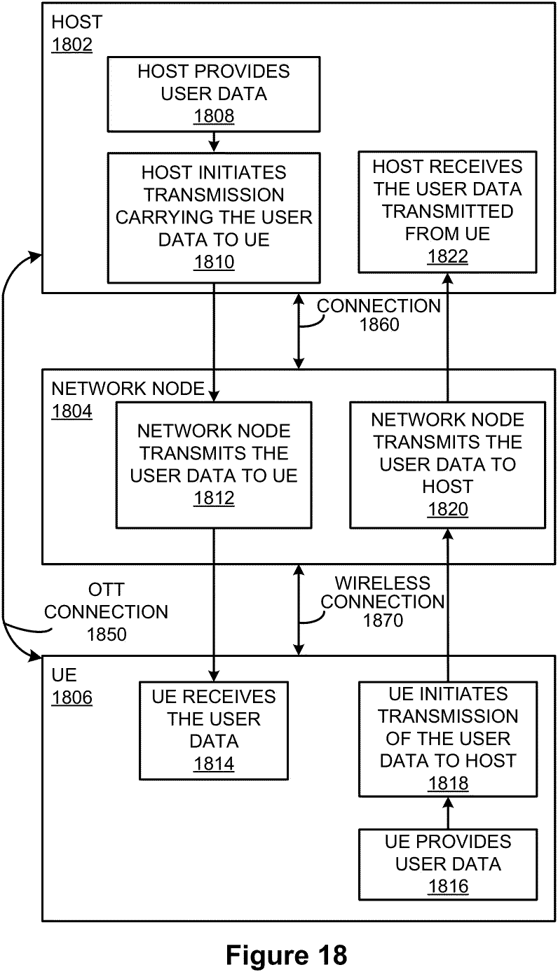

Prior to describing the various embodiments of inventive concepts, FIG. 6 is a block diagram illustrating elements of a communication device UE 600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 600 may be provided, for example, as discussed below with respect to wireless devices UE 1312A, UE 1312B, and wired or wireless devices UE 1312C, UE 1312D of FIG. 13, UE 1400 of FIG. 14, virtualization hardware 1704 and virtual machines 1708A, 1708B of FIG. 17, and UE 1806 of FIG. 18, all of which should be considered interchangeable in the examples and embodiments described herein and be within the intended scope of this disclosure, unless otherwise noted.) As shown, communication device UE may include an antenna 607 (e.g., corresponding to antenna 1422 of FIG. 14), and transceiver circuitry 601 (also referred to as a transceiver, e.g., corresponding to interface 1412 of FIG. 14 having transmitter 1418 and receiver 1420) including a transmitter and a receiver configured to provide uplink and downlink radio communications with a base station(s) (e.g., corresponding to network node 1310A, 1310B of FIG. 13, network node 1500 of FIG. 15, and network node 1804 of FIG. 18 also referred to as a RAN node) of a radio access network. Communication device UE may also include processing circuitry 603 (also referred to as a processor, e.g., corresponding to processing circuitry 1402 of FIG. 14, and control system 1712 of FIG. 17) coupled to the transceiver circuitry, and memory circuitry 605 (also referred to as memory, e.g., corresponding to memory 1410 of FIG. 13) coupled to the processing circuitry. The memory circuitry 605 may include computer readable program code that when executed by the processing circuitry 603 causes the processing circuitry to perform operations according to embodiments disclosed herein. According to other embodiments, processing circuitry 603 may be defined to include memory so that separate memory circuitry is not required. Communication device UE may also include an interface (such as a user interface) coupled with processing circuitry 603, and/or communication device UE may be incorporated in a vehicle.

As discussed herein, operations of communication device UE may be performed by processing circuitry 603 and/or transceiver circuitry 601. For example, processing circuitry 603 may control transceiver circuitry 601 to transmit communications through transceiver circuitry 601 over a radio interface to a radio access network node (also referred to as a base station) and/or to receive communications through transceiver circuitry 601 from a RAN node over a radio interface. Moreover, modules may be stored in memory circuitry 605, and these modules may provide instructions so that when instructions of a module are executed by processing circuitry 603, processing circuitry 603 performs respective operations (e.g., operations discussed below with respect to Example Embodiments relating to wireless communication devices). According to some embodiments, a communication device UE 600 and/or an element(s)/function(s) thereof may be embodied as a virtual node/nodes and/or a virtual machine/machines.

FIG. 7 is a block diagram illustrating elements of a radio access network RAN node 700 (also referred to as a network node, base station, eNodeB/eNB, gNodeB/gNB, etc.) of a Radio Access Network (RAN) configured to provide cellular communication according to embodiments of inventive concepts. (RAN node 700 may be provided, for example, as discussed below with respect to network node 1310A, 1310B of FIG. 13, network node 1500 of FIG. 15, hardware 1704 or virtual machine 1708A, 1708B of FIG. 17, and/or base station 1804 of FIG. 18, all of which should be considered interchangeable in the examples and embodiments described herein and be within the intended scope of this disclosure, unless otherwise noted.) As shown, the RAN node may include transceiver circuitry 701 (also referred to as a transceiver, e.g., corresponding to portions of RF transceiver circuitry 1512 and radio front end circuitry 1518 of FIG. 15) including a transmitter and a receiver configured to provide uplink and downlink radio communications with mobile terminals. The RAN node may include network interface circuitry 707 (also referred to as a network interface, e.g., corresponding to portions of communication interface 1506 of FIG. 15) configured to provide communications with other nodes (e.g., with other base stations) of the RAN and/or core network CN. The network node may also include processing circuitry 703 (also referred to as a processor, e.g., corresponding to processing circuitry 1502 of FIG. 15) coupled to the transceiver circuitry, and memory circuitry 705 (also referred to as memory, e.g., corresponding to memory 1504 of FIG. 15) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that a separate memory circuitry is not required.

As discussed herein, operations of the RAN node may be performed by processing circuitry 703, network interface 707, and/or transceiver 701. For example, processing circuitry 703 may control transceiver 701 to transmit downlink communications through transceiver 701 over a radio interface to one or more mobile terminals UEs and/or to receive uplink communications through transceiver 701 from one or more mobile terminals UEs over a radio interface. Similarly, processing circuitry 703 may control network interface 707 to transmit communications through network interface 707 to one or more other network nodes and/or to receive communications through network interface from one or more other network nodes. Moreover, modules may be stored in memory 705, and these modules may provide instructions so that when instructions of a module are executed by processing circuitry 703, processing circuitry 703 performs respective operations (e.g., operations discussed below with respect to Example Embodiments relating to RAN nodes). According to some embodiments, RAN node 700 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 8 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 800 may be provided, for example, as discussed below with respect to core network node 1308 of FIG. 13, hardware 1704 or virtual machine 1708A, 1708B of FIG. 17, all of which should be considered interchangeable in the examples and embodiments described herein and be within the intended scope of this disclosure, unless otherwise noted) As shown, the CN node may include network interface circuitry 807 configured to provide communications with other nodes of the core network and/or the radio access network RAN. The CN node may also include a processing circuitry 803 (also referred to as a processor,) coupled to the network interface circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the CN node may be performed by processing circuitry 803 and/or network interface circuitry 807. For example, processing circuitry 803 may control network interface circuitry 807 to transmit communications through network interface circuitry 807 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes). According to some embodiments, CN node 500 and/or an element(s)/function(s) thereof may be embodied as a virtual node/nodes and/or a virtual machine/machines.

As previously indicated, the network node (e.g., a RAN node) generates a temporary identifier that can then be mapped to the identifier or identifiers that are subsequently obtained when RAN has fetched them as part of the former UE context. The temporary identifier is a very large (long) random number (LongID), such that the risk of collisions when used in the context of the node, over a short period of time should be very rare. Mapping back to the identifiers can be completed independently from resumption of retrieval of the full UE context.

In some embodiments, a Long identifier (Long ID) is used. It is to be noted that “LongID” and “Long ID” are used interchangeably in this application unless otherwise indicated. The Long ID has the same size (64 bits) as 3GPP defined RAN UE ID (which is today standardized on Xn interface). The same result may be obtained if the RAN generated temporary identifier is mapped back to the globally unique identifier for the node and the interface identifier used by that node in the old UE context. In new radio (NR) RAN, these identifiers could be the Global GnBID and/or the RAN UE XNAP ID.

Thus, a long (e.g., 64bit) random number integer LongID for the UE is used for further tracing purposes. The LongID is included in the failure scenario of context fetching dialog when RRC-Reestablishment occurs. A Long ID is generated when a new UE connects to the base station (e.g., network node). After the UE requests RRC-Reestablishment and the initiation of UE Context Fetch procedure in target node interrogating source node, the LongID is included in two parameters of Trace Records reported together with UE Context Fetch Response or Failure to let the Trace Records Post Processing Tools match the newly generated temporary Long ID with the retained Long ID.

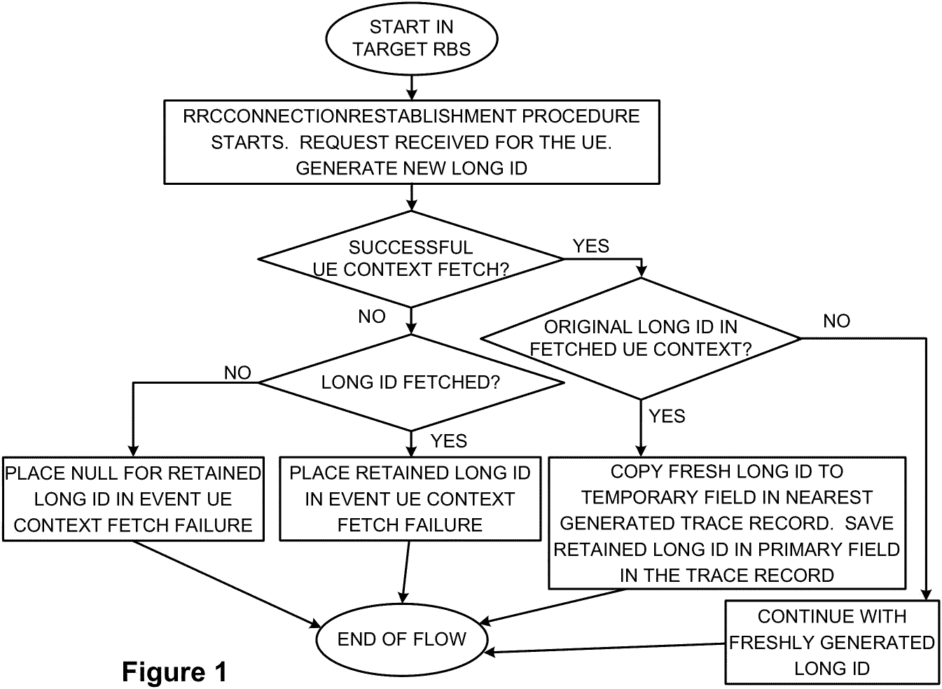

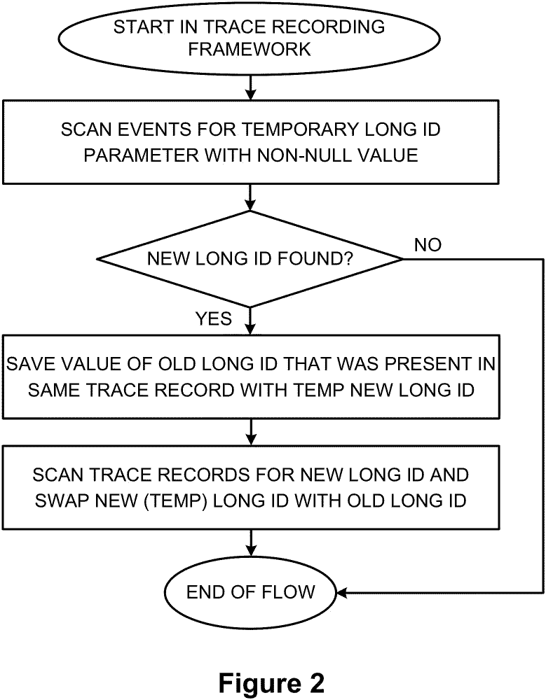

FIG. 1 illustrates an embodiment where the Long ID survives RRC reestablishment during a successful or unsuccessful UE Context Fetch. FIG. 2 illustrates an embodiment of postprocessing of Trace Records parameters containing a temporary Long ID and a retained LongID. Further details of these figures shall be described hereinbelow.

In some embodiments of inventive concepts, the X2AP RRC Reestablishment UE Context Fetch Failure has been amended with LongID parameter. The similar change is applicable also to corresponding message in XnAP.

Two variables are used in Trace Record parameters for Long IDs in certain events in Trace Recording framework, controller and post processing by matching of Temporary Long ID with Retained Long ID and has been done in case of UE Context Fetch Response when both UE Context Fetch and LongID fetch succeeds or in the case when UE Context couldn’t have been fetched but LongID succeeded and is transported in UE Context Fetch Failure and reported by Trace Records parameters described in Table 1.

Table 1

Change in Trace Record’s templates

| | | |
|---|---|---|
| PM Event Name | EventParam Name | Content |
| X2_CONTEXT_FETCH_RESPONSE | EVENT_PARAM_UE_TRACE_ID_RE TAINED(OLD) | Retained LongID |
| | EVENT_PARAM_UE_TRACE_ID_TE MP | New LongID |
| X2_CONTEXT_FETCH_FAILURE | EVENT_PARAM_UE_TRACE_ID_RE TAINED(OLD) | Retained LongID |
| | EVENT_PARAM_UE_TRACE_ID_TE MP | New LongID |

Track reported Trace Records in MS and other Trace Records postprocessing tools to match early LongID with retained LongID.

There are several situations in when LongID is accessible in source node and is sending UE Context Fetch Failure. Examples are below:
1. Ongoing procedure at the reception of the UE Context Fetch Request like E-UTRAN New Radio - Dual Connectivity (ENDC) Setup / Secondary Cell Group (SCG) addition in source eNB
2. There is no cell relation between the source cell and the target cell anymore
3. The handover between source cell and target cell is not allowed

In such cases the UE Context Fetch Response cannot be performed, however LongID can still be retrieved and passed using UE Context Fetch Failure message.

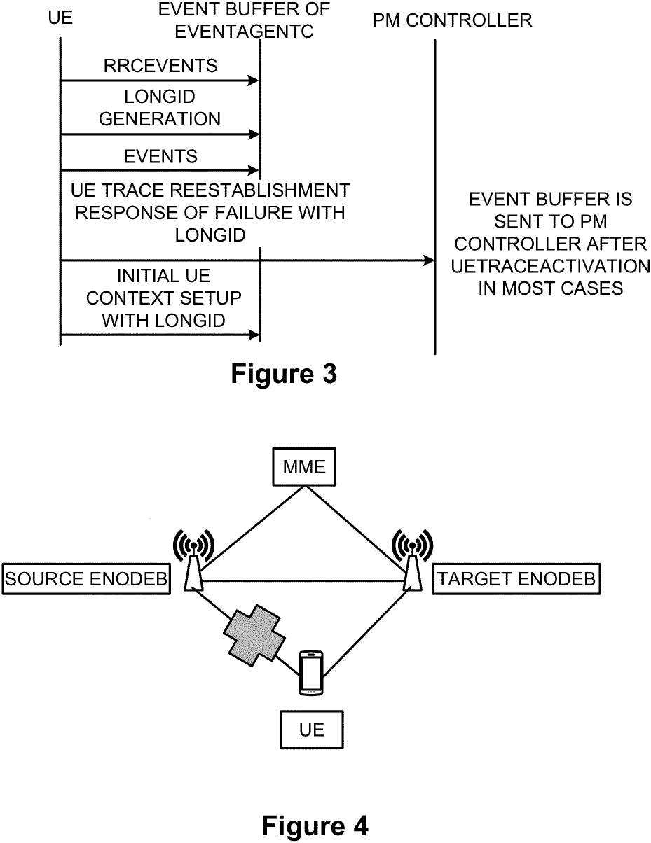

Due to changes in the in-band full-duplex (IFD) and implementation, it is possible for the LongID to survive the RRC Reestablishment procedure. Using a double LongID and the postprocessing algorithm shown in FIG. 2, there is the ability to track and join Trace Records sent for old LongID and in the short period where only the new LongID is known. This is illustrated in FIG. 3 where the LongID is generated during RRC Events and is buffered in the event buffer of event agent C. The LongID is used in the RRC Reestablishment Failure Response procedure where the LongID is used in the initial UE Context Setup.

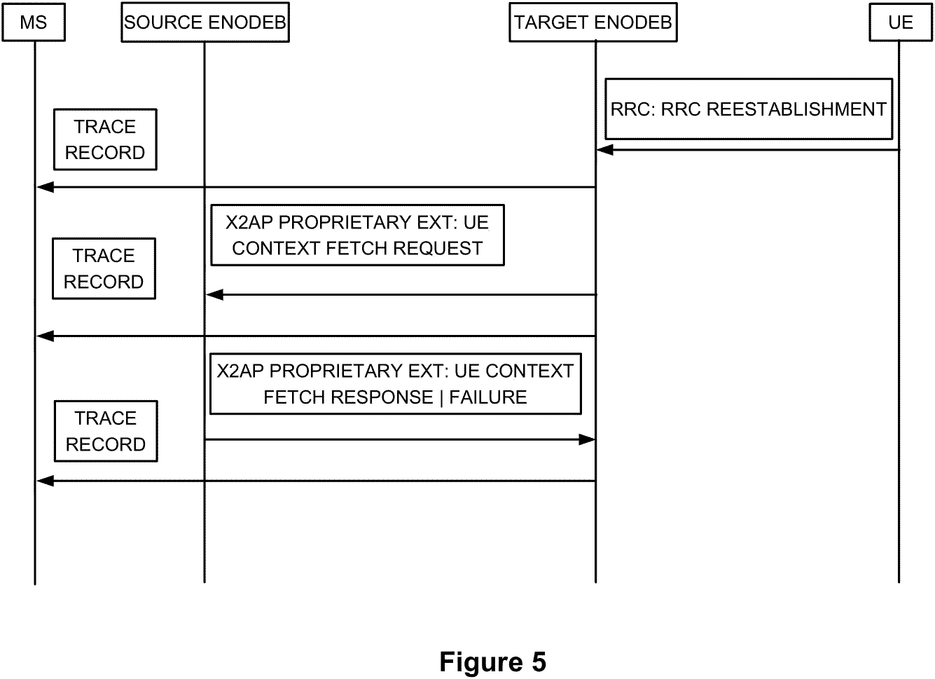

FIG. 4 and FIG. 5 illustrate a scenario in a network where radio link failure (RLF) occurs. In the scenario, two eNodeBs (e.g., source eNodeB and target eNodeB) or two eNodeB cells are connected with the X2AP interface. The network node (e.g., source eNodeB) generates the LongID so the UE has the LongID bound when the UE experiences a lost link with the source eNodeB. After RLF in the source eNodeB, the UE starts RRC-Reestablishment procedure towards the target eNodeB. This target eNodeB continues the UE handling with Context Fetch procedure towards the source eNodeB with following messages:
X2AP UE Context Fetch Request
X2AP UE Context Fetch Response
X2AP UE Context Fetch Failure
X2AP UE Context Fetch Response Accept

It may be impossible to fetch the UE Context in the above scenario, but if the LongID is available in the source node, it can be sent with a failure of fetching UE Context in the UE Context Fetch Failure message.

X2AP UE Context Fetch Failure message and applicable message(s) in XnAP have been amended for X2AP, XnAP protocols in RRC Reestablishment Procedure to carry the LongID.

Trace Records templates have been amended with parameters for recording of the X2 UE Context Fetch Response message and X2 UE Context Fetch Failure messages containing the old (further retained) LongID and the freshly generated new LongID (temporary) to make it possible to connect Trace Recording reported on all periods - when the Radio Base Station (RBS) knows the main Old LongID with the shorted periods when only New LongID is connected to Trace Records in parameters.

Handle double LongIDs in certain events in Trace Recording templates

Table 2

Change in Performance Management Events

| | | |
|---|---|---|
| Trace Record Name | EventParam Name | Content |
| X2_CONTEXT_FETCH_RESPON SE | EVENT_PARAM_LONG_ID _RETAINED(OLD) | Retained Long Id |
| | EVENT_PARAM_LONG_ID _TEMP | New LongId |
| X2_CONTEXT_FETCH_FAILUR E | EVENT_PARAM_LONG_ID _RETAINED(OLD) | Retained Long Id |
| | EVENT_PARAM_LONG_ID _TEMP | New LongId |

In postprocessing of Trace Records it is then possible to track for the known LongID and for temporary LongIDs. If both are found, the Trace Records can be joined in one list connected to old LongID.

For variant 1 (if NULL value is defined and can be used) the flow works even in X2 UE Context Fetch Failure, in case when context fetch failed but LongID transfer was successful.

For variant 2 (no use of NULL value) the flow works after successful UE Context Fetch.

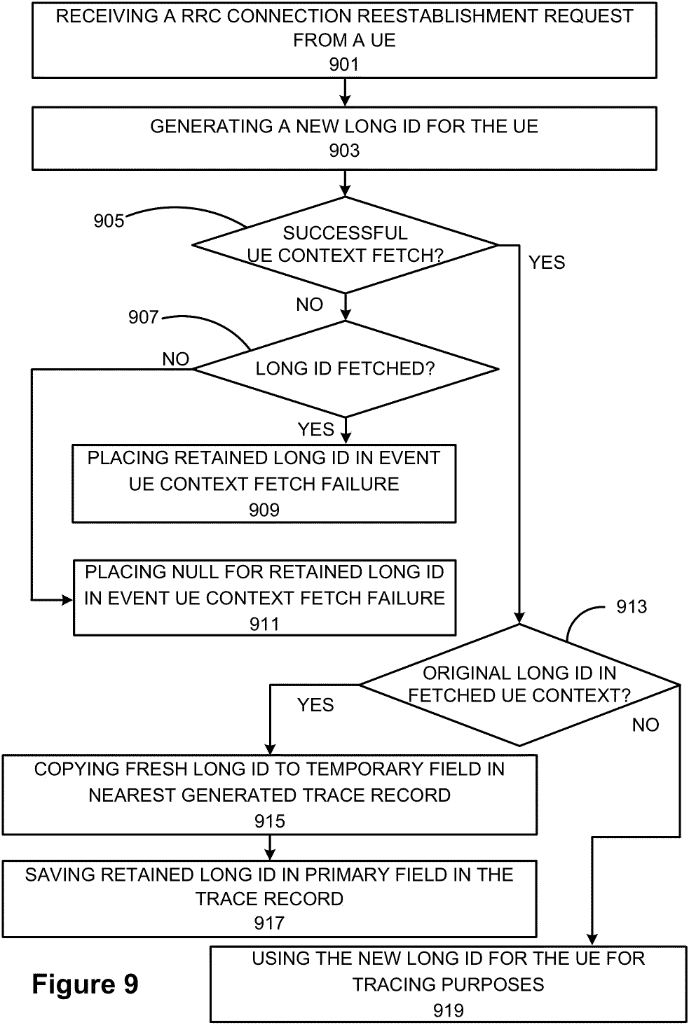

In the description that follows, while the network node may be any of the RAN node 700, network node 1310A, 1310B, 1500, 1806, hardware 1704, or virtual machine 1708A, 1708B, the RAN node 700 shall be used to describe the functionality of the operations of the network node. Operations of the RAN node 700 (implemented using the structure of FIG. 7) will now be discussed with reference to the flow chart of FIG. 9 according to some embodiments of inventive concepts. For example, modules may be stored in memory 705 of FIG. 7, and these modules may provide instructions so that when the instructions of a module are executed by respective RAN node processing circuitry 703, processing circuitry 703 performs respective operations of the flow chart.

Turning to FIG. 9, in block 901, the processing circuitry 703 receives a radio resource control, RRC, connection reestablishment request from a user equipment, UE. In block 903, the processing circuitry 703 generates a new Long identifier, Long ID, for the UE. This new Long ID is a large random number to be associated with the UE until a previously assigned identifier is known (e.g., retained Long ID) as described above.

In block 905, the processing circuitry 703 determines whether a UE Context Fetch is successful. The UE Context Fetch is successful when a UE Context Fetch response is received. The UE Context Fetch is not successful when a UE Context Fetch Failure message is received.

In block 907, the processing circuitry 703, responsive to determining that the UE Context Fetch is not successful, determines whether a Long ID has been fetched. In block 909, the processing circuitry 703, responsive to determining that the Long ID has been fetched, places the Long ID that has been fetched in a UE Context Fetch Failure event.

In block 911, the processing circuitry 703, responsive to determining that the UE Context Fetch is not successful and that the Long ID has not been fetched, places a NULL for the Long ID in the UE Context Fetch Failure event.

In block 913, the processing circuitry 703, responsive to determining that the UE Context Fetch is successful, determines whether an original Long ID is present in the UE Context Fetch.

Responsive to determining that the original Long ID is present in the UE Context Fetch, the processing circuitry 703 performs block 915 and 917. In block 915, the processing circuitry 703 copies the new Long ID to a temporary field in a generated Trace Record. In block 917, the processing circuitry 703 saves the original Long ID in a primary field of the generated Trace Record.

In block 919, the processing circuitry 703, responsive to determining that the original Long ID is not present in the UE Context Fetch, uses the new Long ID for the UE for tracing purposes. The processing circuitry 703 also uses the new Long ID in subsequent RRC connection reestablishment requests.

Various operations from the flow chart of FIG. 9 may be optional with respect to some embodiments of RAN nodes and related methods. Regarding methods of example embodiment 1 (set forth below), for example, operations of blocks 911, 913, 915, 917, and 919 of FIG. 9 may be optional.

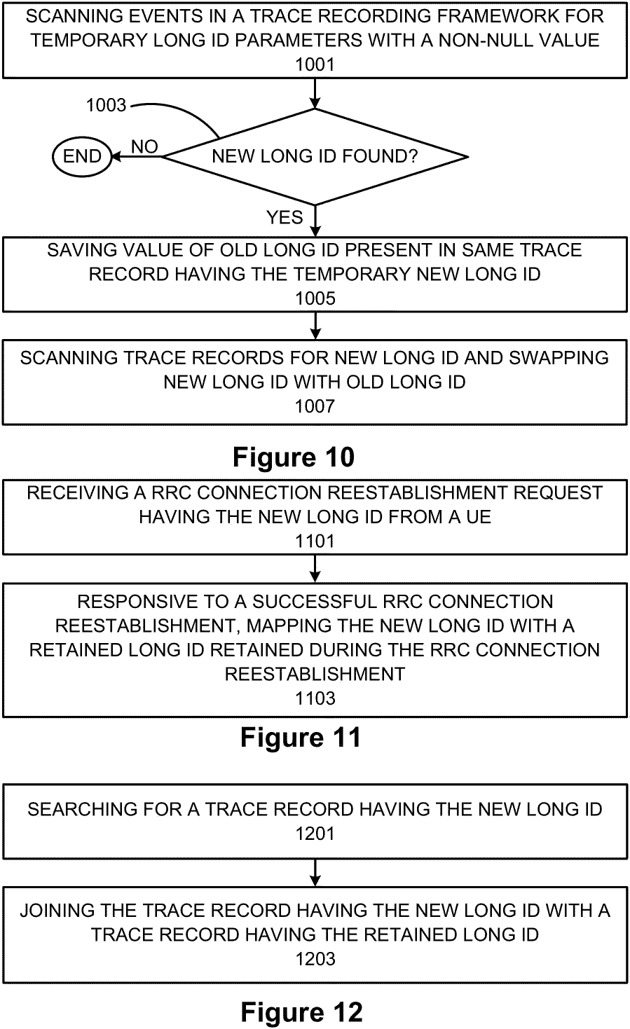

FIG. 10 illustrates an embodiment of inventive concepts where the network node performs postprocessing of Trace Records parameters containing a temporary Long ID and a retained LongID. Turning to FIG. 10, in block 1001, the processing circuitry 703 scans events in a trace recording framework for temporary Long ID parameters with a non-null value. Responsive to a new Long ID being found (i.e., a temporary Long ID found) in block 1003, the processing circuitry 703 saves a value of old Long ID present in same trace record having the temporary Long ID in block 1005 and scans trace records for new long ID and swaps new Long ID with old Long ID in block 1007.

FIG. 11 illustrates some embodiments of inventive concepts where the new Long ID is used in a RRC connection reestablishment. Turning to FIG. 11, in block 1101, the processing circuitry 703 receives a RRC connection reestablishment request having the new Long ID from a UE. In block 1103, the processing circuitry 703, responsive to a successful RRC connection reestablishment, maps the new Long ID with a retained Long ID retained during the RRC connection reestablishment.

FIG. 12 illustrates an embodiment of inventive concepts of mapping the new Long ID with the retained Long ID. Turning to FIG. 12, in block 1201, the processing circuitry 703 searches for a trace record having the new Long ID. In block 1203, the processing circuitry joins the trace record having the new Long ID with a trace record having the retained Long ID

Thus, a large random number is created, to be associated with the UE until a previously assigned identifier is known (LongID). When the previously assigned identifier (such as a RAN UE ID) or identifiers (such as a node id and AP ID) are known, this provides mapping from the new ID to the old ID(s). In X2AP and XnAP, the LongID is included in the UE Context Fetch Failure Message. The eNodeB and management system (MS) handle double LongIDs in certain events in Performance Management. The MS tracks reported Trace Records in MS and other Trace Records postprocessing tools to match early (i.e., new) LongID with retained LongID.

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio - Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub - that is, a hub whose primary function is to route communications to/from the UEs from/to the network node 1310b. In other embodiments, the hub 1314 may be a non-dedicated hub - that is, a device which is capable of operating to route communications between the UEs and network node 1310b, but which is additionally capable of operating as a communication start and/or end point for certain data channels.

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone’s speed information (obtained through a speed sensor) to a second UE that is a remote controller operating the drone. When the user makes changes from the remote controller, the first UE may adjust the throttle on the drone (e.g., by controlling an actuator) to increase or decrease the drone’s speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node’s functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

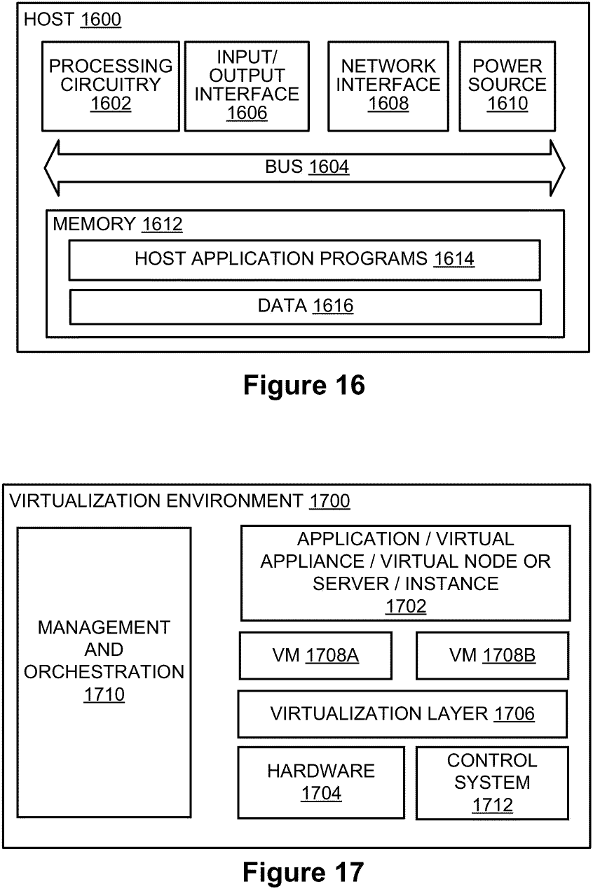

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g., such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE’s processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE’s client application may receive request data from the host’s host application and provide user data in response to the request data. The OTT connection 1850 may transfer both the request data and the user data. The UE’s client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### EMBODIMENTS

1. A method in a network node (700, 1310A, 1310B, 1500, 1704, 1708A, 1708B, 1804) comprising:
   receiving (901) a radio resource control, RRC, connection reestablishment request from a user equipment, UE;
   generating (903) a new Long identifier, ID, for the UE;
   determining (905) whether a UE Context Fetch is successful;
   responsive to determining that the UE Context Fetch is not successful, determining (907) whether a Long ID has been fetched; and
   responsive to determining that the Long ID has been fetched, placing (909) the Long ID that has been fetched in a UE Context Fetch Failure event.
2. The method of Embodiment 1, further comprising responsive to determining that the UE Context Fetch is not successful and that the Long ID has not been fetched, placing (911) a NULL for the Long ID in the UE Context Fetch Failure event.
3. The method of any of Embodiments 1-2 further comprising:
   responsive to determining that the UE Context Fetch is successful, determining (913) whether an original Long ID is present in the UE Context Fetch.
4. The method of Embodiment 3, further comprising:
   responsive to determining that the original Long ID is present in the UE Context Fetch:
   copying (915) the new Long ID to a temporary field in a generated Trace Record; and
   saving (917) the original Long ID in a primary field of the generated Trace Record.
5. The method of Embodiment 3, further comprising:
   responsive to determining that the original Long ID is not present in the UE Context Fetch, using (919) the new Long ID for the UE for tracing purposes.
6. The method of any of Embodiments 1-5, further comprising:
   scanning (1001) events in a trace recording framework for temporary Long ID parameters with a non-null value;
   responsive to a new Long ID being found (1003):
      saving (1005) a value of old Long ID present in same trace record having the temporary new Long ID; and
      scanning (1007) trace records for new Long ID and swapping new Long ID with old Long ID.
7. The method of any of Embodiments 1-6, further comprising:
   receiving (1101) a RRC connection reestablishment request having the new Long ID from a UE; and
   responsive to a successful RRC connection reestablishment, mapping (1103) the new Long ID with a retained Long ID retained during the RRC connection reestablishment.
8. The method of Embodiment 7 wherein mapping the new Long ID with the retained Long ID comprises:
   searching (1201) for a trace record having the new Long ID; and
   joining (1203) the trace record having the new Long ID with a trace record having the retained Long ID.
9. A radio access network, RAN, node (700, 1310A, 1310B, 1500, 1704, 1708A, 1708B, 1804) comprising:
   processing circuitry (703, 1502); and
   memory (405, 4180, 4390) coupled with the processing circuitry, wherein the memory includes instructions that when executed by the processing circuitry causes the RAN node to perform operations comprising:
   receiving (901) a radio resource control, RRC, connection reestablishment request from a user equipment, UE;
   generating (903) a new Long identifier, ID, for the UE;
   determining (905) whether a UE Context Fetch is successful;
   responsive to determining that the UE Context Fetch is not successful, determining (907) whether a Long ID has been fetched; and
   responsive to determining that the Long ID has been fetched, placing (909) the Long ID that has been fetched in a UE Context Fetch Failure event.
10. The RAN node (700, 1310A, 1310B, 1500, 1704, 1708A, 1708B, 1804) of Embodiment 9 wherein the memory includes further instructions that when executed by the processing circuitry causes the RAN node to perform operations according to any of Embodiments 2-8.
11. A radio access network, RAN, node (700, 1310A, 1310B, 1500, 1704, 1708A, 1708B, 1804) adapted to perform operations comprising:
   receiving (901) a radio resource control, RRC, connection reestablishment request from a user equipment, UE;
   generating (903) a new Long identifier, ID, for the UE;
   determining (905) whether a UE Context Fetch is successful;
   responsive to determining that the UE Context Fetch is not successful, determining (907) whether a Long ID has been fetched; and
   responsive to determining that the Long ID has been fetched, placing (909) the Long ID that has been fetched in a UE Context Fetch Failure event.
12. The RAN node (700, 1310A, 1310B, 1500, 1704, 1708A, 1708B, 1804) of Embodiment 11 wherein the RAN node is adapted to perform any of Embodiments 2-8.
13. A computer program comprising program code to be executed by processing circuitry (703, 1502) of a radio access network, RAN, node (700, 1310A, 1310B, 1500, 1704, 1708A, 1708B, 1804), whereby execution of the program code causes the RAN node (700, 1310A, 1310B, 1500, 1704, 1708A, 1708B, 1804) to perform operations comprising:
   receiving (901) a radio resource control, RRC, connection reestablishment request from a user equipment, UE;
   generating (903) a new Long identifier, ID, for the UE;
   determining (905) whether a UE Context Fetch is successful;
   responsive to determining that the UE Context Fetch is not successful, determining (907) whether a Long ID has been fetched; and
   responsive to determining that the Long ID has been fetched, placing (909) the Long ID that has been fetched in a UE Context Fetch Failure event.
14. The computer program of Embodiment 13 comprising further program code whereby execution of the program code causes the RAN node (700, 1310A, 1310B, 1500, 1704, 1708A, 1708B, 1804) to perform operations according to any of embodiments 2-8.
15. A computer program product comprising a non-transitory storage medium including program code to be executed by processing circuitry (703, 1502) of a radio access network, RAN, node (700, 1310A, 1310B, 1500, 1704, 1708A, 1708B, 1804), whereby execution of the program code causes the RAN node (700, 1310A, 1310B, 1500, 1704, 1708A, 1708B, 1804) to perform operations comprising:
   receiving (901) a radio resource control, RRC, connection reestablishment request from a user equipment, UE;
   generating (903) a new Long identifier, ID, for the UE;
   determining (905) whether a UE Context Fetch is successful;
   responsive to determining that the UE Context Fetch is not successful, determining (907) whether a Long ID has been fetched; and
   responsive to determining that the Long ID has been fetched, placing (909) the Long ID that has been fetched in a UE Context Fetch Failure event.
16. The computer program product of Embodiment 15 wherein the non-transitory storage medium includes further program code whereby execution of the program code causes the RAN node (700, 1310A, 1310B, 1500, 1704, 1708A, 1708B, 1804) to perform operations according to any of Embodiments 2-8.

Explanations are provided below for various abbreviations/acronyms used in the present disclosure.

| | |
|---|---|
| Abbreviation | Explanation |
| MME | Mobility Management Entity |
| MS | Management System |
| IE | Information Element |
| IFD | Interface Description |
| RRC | Radio Resource Control |
| X2AP | eNodeB to eNodeB interface |
| UE | User Equiptment |
| LongID | ID for binding performance management events to UE with privacy |

1. A method in a network node comprising:
receiving a radio resource control, RRC, connection reestablishment request from a user equipment, UE;
generating a new Long identifier, ID, for the UE;
determining whether a UE Context Fetch is successful;
responsive to determining that the UE Context Fetch is not successful, determining whether a Long ID has been fetched; and
responsive to determining that the Long ID has been fetched, placing the Long ID that has been fetched in a UE Context Fetch Failure event.

2. The method of claim 1, further comprising responsive to determining that the UE Context Fetch is not successful and that the Long ID has not been fetched, placing a NULL for the Long ID in the UE Context Fetch Failure event.

3. The method of claim 1, further comprising:
responsive to determining that the UE Context Fetch is successful, determining whether an original Long ID is present in the UE Context Fetch.

4. The method of claim 3, further comprising:
responsive to determining that the original Long ID is present in the UE Context Fetch:
copying the new Long ID to a temporary field in a generated Trace Record; and
saving the original Long ID in a primary field of the generated Trace Record.

5. The method of claim 3, further comprising:
responsive to determining that the original Long ID is not present in the UE Context Fetch, using the new Long ID for the UE for tracing purposes.

6. The method of claim 1, further comprising:
scanning events in a trace recording framework for temporary Long ID parameters with a non-null value;
responsive to a new Long ID being found:
saving a value of old Long ID present in same trace record having the temporary new Long ID; and
scanning trace records for new Long ID and swapping new Long ID with old Long ID.

7. The method of claim 1, further comprising:
receiving a RRC connection reestablishment request having the new Long ID from a UE; and
responsive to a successful RRC connection reestablishment, mapping the new Long ID with a retained Long ID retained during the RRC connection reestablishment.

8. The method of claim 7 wherein mapping the new Long ID with the retained Long ID comprises:
searching for a trace record having the new Long ID; and
joining the trace record having the new Long ID with a trace record having the retained Long ID.

9. A radio access network (RAN) node comprising:
processing circuitry; and
memory coupled with the processing circuitry, wherein the memory includes instructions that when executed by the processing circuitry causes the RAN node to perform operations comprising:
receiving a radio resource control (RRC) connection reestablishment request from a user equipment (UE);
generating a new Long identifier, ID, for the UE;
determining whether a UE Context Fetch is successful;
responsive to determining that the UE Context Fetch is not successful, determining whether a Long ID has been fetched; and
responsive to determining that the Long ID has been fetched, placing the Long ID that has been fetched in a UE Context Fetch Failure event.

10. The RAN node of claim 9, wherein the memory includes further instructions that when executed by the processing circuitry causes the RAN node to perform operations comprising:
responsive to determining that the UE Context Fetch is not successful and that the Long ID has not been fetched, placing a NULL for the Long ID in the UE Context Fetch Failure event.

11. The RAN node of claim 9, wherein the memory includes further instructions that when executed by the processing circuitry causes the RAN node to perform operations comprising:
responsive to determining that the UE Context Fetch is successful, determining whether an original Long ID is present in the UE Context Fetch.

12. The RAN node of claim 11, wherein the memory includes further instructions that when executed by the processing circuitry causes the RAN node to perform operations comprising:
responsive to determining that the original Long ID is present in the UE Context Fetch:
copying the new Long ID to a temporary field in a generated Trace Record; and
saving the original Long ID in a primary field of the generated Trace Record.

13. The RAN node of claim 11, wherein the memory includes further instructions that when executed by the processing circuitry causes the RAN node to perform operations comprising:
responsive to determining that the original Long ID is not present in the UE Context Fetch, using the new Long ID for the UE for tracing purposes.

14. The RAN node of claim 9, wherein the memory includes further instructions that when executed by the processing circuitry causes the RAN node to perform operations comprising:
scanning events in a trace recording framework for temporary Long ID parameters with a non-null value;
responsive to a new Long ID being found:
saving a value of old Long ID present in same trace record having the temporary new Long ID; and
scanning trace records for new Long ID and swapping new Long ID with old Long ID.

15. The RAN node of claim 9, wherein the memory includes further instructions that when executed by the processing circuitry causes the RAN node to perform operations comprising:
receiving a RRC connection reestablishment request having the new Long ID from a UE; and
responsive to a successful RRC connection reestablishment, mapping the new Long ID with a retained Long ID retained during the RRC connection reestablishment.

16. The RAN node of claim 15 wherein the memory includes instructions that when executed by the processing circuitry causes the RAN node to map the new Long ID with the retained Long ID by:
searching for a trace record having the new Long ID; and
joining the trace record having the new Long ID with a trace record having the retained Long ID.

17. A computer program product comprising a non-transitory storage medium including program code to be executed by processing circuitry of a radio access network, RAN, node, whereby execution of the program code causes the RAN node to perform operations comprising:
receiving a radio resource control, RRC, connection reestablishment request from a user equipment, UE;
generating a new Long identifier, ID, for the UE;
determining whether a UE Context Fetch is successful;
responsive to determining that the UE Context Fetch is not successful, determining whether a Long ID has been fetched; and
responsive to determining that the Long ID has been fetched, placing the Long ID that has been fetched in a UE Context Fetch Failure event.

18. The computer program product of claim 17 wherein the non-transitory storage medium includes further program code whereby execution of the program code causes the RAN node to perform operations comprising:
responsive to determining that the UE Context Fetch is not successful and that the Long ID has not been fetched, placing a NULL for the Long ID in the UE Context Fetch Failure event.

19. The computer program product of claim 17 wherein the non-transitory storage medium includes further program code whereby execution of the program code causes the RAN node to perform operations comprising:
responsive to determining that the UE Context Fetch is successful, determining whether an original Long ID is present in the UE Context Fetch;
responsive to determining that the original Long ID is present in the UE Context Fetch:
copying the new Long ID to a temporary field in a generated Trace Record; and
saving the original Long ID in a primary field of the generated Trace Record.

20. The computer program product of claim 17 wherein the non-transitory storage medium includes further program code whereby execution of the program code causes the RAN node to perform operations comprising:
receiving a RRC connection reestablishment request having the new Long ID from a UE; and
responsive to a successful RRC connection reestablishment, mapping the new Long ID with a retained Long ID retained during the RRC connection reestablishment.
